(19) United States
(12) Patent Application Publication
(10) Pub. No.: US 2026/0206108 A1
(43) Pub. Date: Jul. 16, 2026

(54) LIGHT SOURCE CONTROL METHOD, LIGHT-EMITTING ASSEMBLY, AND AUDIO DEVICE

(71) Applicant: HARMAN INTERNATIONAL INDUSTRIES, INCORPORATED, Stamford, CT (US)

(72) Inventor: Rongjian HUANG, Shenzhen (CN)

(21) Appl. No.: 19/439,821

(22) Filed: Jan. 5, 2026

(30) Foreign Application Priority Data
Jan. 15, 2025 (CN) 202510069222.7

(51) Int. Cl. H05B 45/18

(52) U.S. Cl. CPC H05B 45/18

(57) ABSTRACT

The present disclosure provides a light source control method, a light-emitting assembly, an audio device, and a computer-readable storage medium. The light source control method includes: acquiring light-emitting pattern data for controlling light-emitting characteristics of a light source array, the light source array including a plurality of light sources; measuring a temperature of the light source array in real time using a temperature sensor; determining, based on the light-emitting pattern data and the temperature of the light source array, to adjust the light source array from a first average brightness level to a second average brightness level; and controlling light-emitting characteristics of each light source in the light source array non-proportionally based on the second average brightness level and the light-emitting pattern data, such that the light source array displays a light-emitting pattern corresponding to the light-emitting pattern data while satisfying the second average brightness level.

### CROSS-REFERENCE TO RELATED APPLICATIONS

This application claims priority benefit to Chinese Patent Application Number 202510069222.7 entitled “LIGHT SOURCE CONTROL METHOD, LIGHT-EMITTING ASSEMBLY, AND AUDIO DEVICE,” filed Jan. 15, 2025. The subject matter of this related application is hereby incorporated herein by reference.

### BACKGROUND

### Field of the Various Embodiments

The present disclosure relates to the field of lighting technology, and more particularly, to a light source control method, a light-emitting assembly, an audio device, and a computer-readable storage medium.

### Description of the Related Art

An increasing number of consumer products integrate light sources internally for purposes such as illumination, decoration, signal indication, feature highlighting, and ambiance creation, aiming to provide a better user experience in various application scenarios. For example, some audio products such as acoustics integrate light-emitting diode (LED) arrays internally, which can produce dynamic light shows synchronized with musical melodies. However, after prolonged operation, a light source inevitably experiences heating and even overheating phenomena, leading to performance degradation of the device containing the light source, device malfunction, electrical safety hazards, or even fire hazards. Therefore, how to properly handle the heat generation phenomenon of light sources is an important issue in product design. Existing methods for handling light source heat generation either have high costs, reduce the performance of the light source, or affect the appearance and protection design of the product. There is a lack of a method that can address the light source heat generation problem simply and efficiently without compromising the overall performance of the light source.

### SUMMARY

The present disclosure provides a light source control method, a light-emitting assembly, an audio device, and a computer-readable storage medium.

According to at least one aspect of the present disclosure, a light source control method is provided, including: acquiring light-emitting pattern data for controlling light-emitting characteristics of a light source array, the light source array including a plurality of light sources; measuring a temperature of the light source array in real time using a temperature sensor; determining, based on the light-emitting pattern data and the temperature of the light source array, to adjust the light source array from a first average brightness level to a second average brightness level; and controlling light-emitting characteristics of each light source in the light source array non-proportionally based on the second average brightness level and the light-emitting pattern data, such that the light source array displays a light-emitting pattern corresponding to the light-emitting pattern data while satisfying the second average brightness level.

In one or more embodiments of the present disclosure, the light-emitting pattern data includes data for controlling one or more of turning on or off, brightness, emission color, emission time, emission direction, rotation, or movement of each light source in the light source array in each time frame.

In one or more embodiments of the present disclosure, determining, based on the light-emitting pattern data and the temperature of the light source array, to adjust the light source array from the first average brightness level to the second average brightness level includes: determining, in a case where the temperature of the light source array is greater than a first predetermined threshold, to decrease the light source array from the first average brightness level to the second average brightness level; and determining, in a case where the temperature of the light source array is less than a second predetermined threshold, to increase the light source array from the first average brightness level to the second average brightness level.

In one or more embodiments of the present disclosure, controlling the light-emitting characteristics of each light source in the light source array non-proportionally based on the second average brightness level and the light-emitting pattern data includes: while causing the light source array to satisfy the second average brightness level, increasing brightness of a first part of light sources in the light source array and decreasing brightness of a second part of light sources in the light source array based on the light-emitting pattern data.

In one or more embodiments of the present disclosure, controlling the light-emitting characteristics of each light source in the light source array non-proportionally based on the second average brightness level and the light-emitting pattern data includes: while causing the light source array to satisfy the second average brightness level, adjusting brightness of each light source in a first part of light sources in the light source array to be greater than a temporary value thereof and adjusting brightness of each light source in a second part of light sources in the light source array to be less than a temporary value thereof based on the light-emitting pattern data.

In one or more embodiments of the present disclosure, the temporary value of each light source in the light source array is a brightness value of the light source in a case where brightness of all light sources is adjusted proportionally to cause the light source array to reach the second average brightness level.

In one or more embodiments of the present disclosure, acquiring the light-emitting pattern data for controlling the light-emitting characteristics of the light source array includes: acquiring the light-emitting pattern data from a local memory; or receiving the light-emitting pattern data from a remote device in a wired or wireless manner.

According to at least one aspect of the present disclosure, a light-emitting assembly is provided, including: a light source array, the light source array including a plurality of light sources; a temperature sensor configured to measure a temperature of the light source array in real time; a first control unit configured to determine, based on light-emitting pattern data and the temperature of the light source array, to adjust the light source array from a first average brightness level to a second average brightness level; a second control unit configured to generate, based on the second average brightness level and the light-emitting pattern data, control data for non-proportionally controlling light-emitting characteristics of each light source in the light source array; and a driving unit configured to use the control data to drive the light source array to emit light, such that the light source array displays a light-emitting pattern corresponding to the light-emitting pattern data while satisfying the second average brightness level.

According to at least one aspect of the present disclosure, an audio device is provided, including the light-emitting assembly according to the aforementioned aspects of the present disclosure.

According to at least one aspect of the present disclosure, a computer-readable storage medium is provided, which has computer-readable instructions stored thereon, where the computer-readable instructions, when executed by a processor, cause the processor to execute the method according to the aforementioned aspects of the present disclosure.

According to at least one aspect of the present disclosure, a computer program product is provided, including computer-readable instructions, where the computer-readable instructions, when executed by a processor, cause the processor to execute the method according to the aforementioned aspects of the present disclosure.

By utilizing the light source control method, the light-emitting assembly, and the audio device according to the embodiments of the present disclosure, the temperature of the light source array can be monitored in real time and the average brightness level of the light source array can be adjusted accordingly to eliminate overheating risks, without sacrificing the overall light-emitting performance of the light source array. Additionally, apparent parameters of the light-emitting pattern, such as contrast and color saturation, which are more readily noticeable to users, can be improved. Furthermore, various steps of the light source control method according to one or more embodiments of the present disclosure can be easily implemented via software control logic without increasing additional hardware design and implementation costs, thereby allowing flexible application to various types of consumer products containing light sources.

### BRIEF DESCRIPTION OF THE DRAWINGS

The above and other objects, features and advantages of the embodiments of the present disclosure will become more apparent through a more detailed description of the embodiments of the present disclosure in conjunction with the accompanying drawings. The accompanying drawings are used to provide further understanding of the embodiments of the present disclosure and constitute a part of the specification. They are used to explain the present disclosure together with the embodiments of the present disclosure and do not constitute a limitation of the present disclosure. In the accompanying drawings, like reference numerals generally represent like components or steps.

FIG. 1 illustrates a flowchart of a light source control method according to one or more embodiments of the present disclosure;

FIG. 2 illustrates an example of proportional control of brightness of light sources in a light source array according to one or more embodiments of the present disclosure;

FIG. 3 illustrates an example of non-proportional control of brightness of light sources in a light source array according to one or more embodiments of the present disclosure;

FIG. 4 illustrates a schematic structural diagram of a light-emitting assembly according to one or more embodiments of the present disclosure; and

FIG. 5 illustrates a process flow of an example light-emitting assembly according to one or more embodiments of the present disclosure.

### DETAILED DESCRIPTION

The technical solutions in the embodiments of the present disclosure will be clearly and completely described below in conjunction with the accompanying drawings in the embodiments of the present disclosure. Obviously, the described embodiments are only some of the embodiments of the present disclosure, rather than all the embodiments. Based on the embodiments of the present disclosure, all other embodiments obtained by those of ordinary skill in the art without making creative effort shall fall within the scope of protection of the present disclosure.

As used in the embodiments of the present disclosure, unless otherwise indicated clearly in the context, the words “a,” “an,” “a kind of,” and/or “the”, and the like do not refer specifically to the singular, but may also include the plural. The words “first,” “second,” and the like used in the present disclosure do not indicate any order, quantity or importance, but are only used to distinguish different components. Similarly, the words “including,” “comprising,” and the like mean that the element or object preceding the words includes the elements or objects listed after the words and equivalents thereof, but do not exclude other elements or objects. Similar words such as “connected” and “connecting” are not limited to physical or mechanical connections, but may include electrical connections, whether direct or indirect.

In the embodiments of the present disclosure, the term “module” or “unit” refers to a computer program or a segment of a computer program that has a predetermined function and works together with other related parts to achieve a predetermined goal, and can be implemented entirely or in part by using software, hardware (such as a processing circuit or memory), or a combination thereof. Likewise, one processor (or a plurality of processors or memories) can be used for implementing one or more modules or units. Furthermore, each module or unit may be a part of an integral module or unit that includes the function of the module or unit.

Furthermore, flowcharts are used in the present disclosure to illustrate operations performed by a system according to embodiments of the present disclosure. It should be understood that the preceding or following operations are not necessarily performed precisely in sequence. Instead, various steps may be processed in a reverse order or concurrently. Meanwhile, it is also possible to add other operations to these processes or to remove a step or steps from these processes.

In the embodiments of the present disclosure, a “light source” is defined as a source of light (e.g., a light emitter configured to generate and emit light). For example, a light source may include a light emitter such as a light-emitting diode (LED) that emits light when activated or turned on. Specifically, herein, a light source may be substantially any source of light or substantially include any light emitter, including but not limited to one or more of a light-emitting diode (LED), a laser, an organic light-emitting diode (OLED), a polymer light-emitting diode, a plasma-based light emitter, a fluorescent lamp, an incandescent lamp, and nearly any other light source. Light produced by a light source may have a color (i.e., may include light of specific wavelengths), or may be within a certain wavelength range (e.g., white light). For example, different colors may include primary colors (e.g., red, green, blue) as well as any other colors.

Due to reasons such as electrical energy conversion efficiency, resistive heating, and energy dissipation, a light source generates heat during operation and may even overheat after prolonged operation, especially under conditions such as excessively high ambient temperature or poor heat dissipation conditions. To avoid potential device malfunctions and safety hazards caused by overheating, it is necessary to properly handle the heat generation problem of light sources. A common practice is to add heat dissipation structures or heat dissipation materials to the device containing the light source, but this requires the device to have sufficient space allowance, which increases the design difficulty and cost for some small devices (e.g., portable mini acoustics). Another method is to provide heat dissipation channels (e.g., heat dissipation holes, heat dissipation windows, etc.) on the device surface for light sources, but this affects the appearance and protection design of the device, for example, potentially making the device non-waterproof. It is also possible to reduce the heat emitted by the light source by lowering its brightness, but reducing the brightness may affect the performance of the light source. For example, for light sources intended to display light shows, insufficient brightness will degrade the user experience.

To address the aforementioned problems, the present disclosure proposes a light source control method, which can effectively reduce the energy consumption of the light source with a relatively low implementation cost while maintaining the overall performance of the light source, thereby lowering the overheating risk of the device containing the light source.

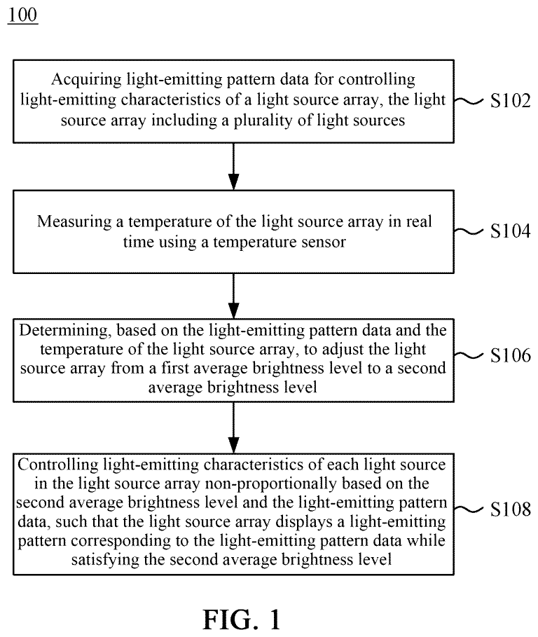

A light source control method according to one or more embodiments of the present disclosure is described below with reference to FIG. 1. FIG. 1 illustrates a flowchart of a light source control method 100 according to one or more embodiments of the present disclosure.

As shown in FIG. 1, in step S102, light-emitting pattern data for controlling light-emitting characteristics of a light source array is acquired. In one or more embodiments of the present disclosure, the light source array may include a plurality of light sources. The plurality of light sources may be arranged into a one-dimensional, two-dimensional, or three-dimensional array according to any pattern, for example, arranged into a specific pattern, which is not specifically limited in the embodiments of the present disclosure. As mentioned above, each light source in the light source array may be an LED, OLED, laser light source, etc., and each light source may emit light of a different color, which is not specifically limited in the embodiments of the present disclosure. For example, the light source array may be integrated into other devices such as a light-emitting assembly, a display device, an audio device, etc., to provide functions such as illumination, decoration, signal indication, feature highlighting, and ambiance creation for the device.

In one or more embodiments of the present disclosure, the light-emitting pattern data is data for controlling the light-emitting characteristics of the light source array. Specifically, it may include data for controlling one or more of turning on or off, brightness, emission color, emission time, emission direction, rotation, or movement of each light source in the light source array in each time frame. Thus, based on this light-emitting pattern data, the light-emitting characteristics of each light source in the light source array can be controlled, such that the light emitted by the light source array as a whole can form specific light-emitting patterns, such as flowers, animals, landscapes, etc. According to one or more embodiments of the present disclosure, the light-emitting pattern data may be preset and stored in a local memory of the device containing the light source array. Then, in step S102, the light-emitting pattern data may be obtained from the local memory. According to one or more embodiments of the present disclosure, the light-emitting pattern data may be received from a remote device (e.g., a smart device, a server, the cloud, etc.) in a wired or wireless manner. For example, the device containing the light source array may receive the light-emitting pattern data from the remote device using a wireless method such as Bluetooth or WiFi.

As mentioned above, the light source array may have an overheating risk after prolonged operation. To monitor the temperature of the light source array in real time, in step S104, a temperature sensor may be used to measure the temperature of the light source array in real time. Here, “measuring in real time” or “measuring in near real time” may refer to measuring at relatively small time intervals, which may be preset based on actual design requirements, for example. Additionally, the temperature sensor may also be used to monitor other components within the device that may generate heat, for example, a power supply, a processor, a storage device, etc. The heat generated by these components, combined with the heat generated by the light source array, may cause the device to overheat, thereby affecting the performance of the device and creating safety hazards. The light source array, as a primary heat source, can effectively reduce the overheating risk of the device if its heat generation can be controlled within a safe range.

In step S106, based on the light-emitting pattern data and the temperature of the light source array, it may be determined to adjust an average brightness level of the light source array, so as to adjust the light source array from a first average brightness level to a second average brightness level. The light-emitting pattern data may be used to control the brightness of each light source in the light source array. The combined brightness of all light sources determines the average brightness level of the light source array. If the average brightness level of the light source array is too high, meaning that the power consumption is too high, it may cause the light source array to overheat. At this point, the temperature of the light source array measured by the temperature sensor may exceed a first predetermined threshold. In a case where the temperature of the light source array is greater than the first predetermined threshold, the average brightness level of the light source array may be adjusted. For example, the first average brightness level L1 of the light source array may be decreased by a certain percentage to a second average brightness level L2 (in this case, L1>L2) to reduce the overall power consumption of the light source array, thereby achieving the purpose of lowering the temperature of the light source array.

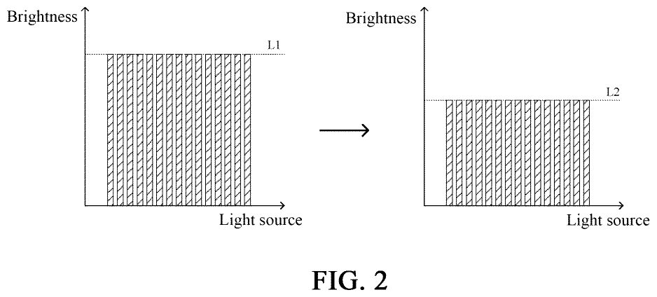

Typically, proportional control may be applied to the brightness level of the light source array, i.e., increasing or decreasing the brightness of all light sources in the light source array by the same proportion, as shown in FIG. 2. FIG. 2 illustrates an example of proportional control of brightness of light sources in a light source array according to one or more embodiments of the present disclosure, where respective bars represent different light sources in the light source array (15 light sources are exemplarily shown in the figure), and a vertical axis represents the brightness of the light sources. In FIG. 2, an initial brightness level of all light sources in the light source array is L1, i.e., a first (or initial) average brightness level is L1. Subsequently, the brightness level of all light sources in the light source array is proportionally decreased to L2, and thus the average brightness level of the light source array is also decreased to a second average brightness level L2. However, this method of proportionally controlling brightness may degrade the performance of the light source array. For example, users may noticeably observe a decrease in the brightness of the light source array, thereby reducing the user experience.

In one or more embodiments of the present disclosure, in step S108, light-emitting characteristics of each light source in the light source array may be controlled non-proportionally based on the second average brightness level and the light-emitting pattern data, such that the light source array displays a light-emitting pattern corresponding to the light-emitting pattern data while satisfying the second average brightness level. Specifically, for example, while causing the light source array to satisfy the second average brightness level, brightness of a first part of light sources in the light source array may be increased and brightness of a second part of light sources in the light source array may be decreased based on the light-emitting pattern data. That is, the brightness of each light source in the light source array is adjusted at a different level or proportion.

Furthermore, it is assumed that, in a case where brightness of all light sources in the light source array is adjusted proportionally to cause the light source array to reach the second average brightness level, the brightness of each light source is set to a temporary value. In step S108 of the light source control method according to one or more embodiments of the present disclosure, brightness of each light source in a first part of light sources in the light source array may be adjusted to be greater than a temporary value thereof, and brightness of each light source in a second part of light sources in the light source array may be adjusted to be less than a temporary value thereof based on the light-emitting pattern data.

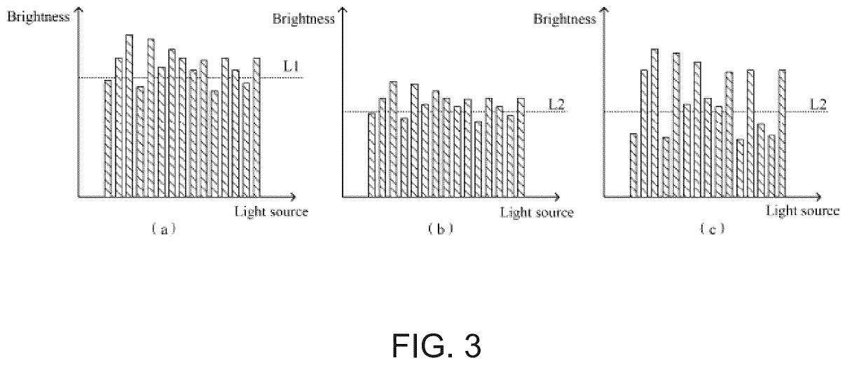

Reference is made to FIG. 3 for description. FIG. 3 illustrates an example of non-proportional control of brightness of light sources in a light source array according to one or more embodiments of the present disclosure. In Example (a) of FIG. 3, a first (or initial) average brightness level of the light source array is L1, and the light sources have different brightness for forming a light-emitting pattern with specific contrast. If the brightness of all light sources in the light source array is adjusted proportionally to cause the light source array to reach a second average brightness level L2, the brightness of the light sources should be the temporary values shown in Example (b) of FIG. 3. In contrast, in step S108 of the light source control method according to one or more embodiments of the present disclosure, brightness of each light source in one part of the light sources may be adjusted to be greater than a temporary value thereof, and brightness of each light source in another part of the light sources may be adjusted to be less than a temporary value thereof based on the light-emitting pattern data, as shown in Example (c) of FIG. 3.

The specific adjustment logic for the light sources in the light source array may be determined based on the characteristics of the light-emitting pattern. For example, if one part of the desired light-emitting pattern is brighter and another part is darker, the brightness of the light sources corresponding to the brighter pattern part may be adjusted to be greater than their temporary values, while the brightness of the light sources corresponding to the darker pattern part may be adjusted to be less than their temporary values, while ensuring that the overall average brightness level of the light-emitting pattern is lowered. Combining with a specific example for illustration, for instance, if the light-emitting pattern corresponding to the light-emitting pattern data is a night sky, under the premise of lowering the overall average brightness level of the light-emitting pattern, the brightness of the light sources corresponding to the moon and stars may be adjusted to be greater than their temporary values, and the brightness of the light sources corresponding to the sky may be adjusted to be less than their temporary values, for example, the corresponding light sources may be directly turned off.

Through this non-proportional adjustment method, the brightness of the parts of the light-emitting pattern that users focus more on (e.g., the moon and stars) does not decrease significantly, and may even increase, while the brightness of the parts of the light-emitting pattern that users pay less attention to (e.g., the night sky) decreases significantly. Thus, although the average brightness level of the light-emitting pattern drops, users may not perceive a significant change in brightness, and the contrast of the light-emitting pattern can also be improved. Similarly, light-emitting characteristics such as turning on or off, emission color, and emission direction of each light source in the light source array may also be controlled non-proportionally, thereby improving the color saturation of the light-emitting pattern.

Since the temperature sensor measures the temperature of the light source array in near real time, in a case where the detected temperature of the light source array is less than a second predetermined threshold, for example, when the temperature of the light source array has dropped to a level far insufficient to cause an overheating risk, in order to provide better light-emitting performance, the average brightness level of the light source array may be increased, for example, increased from a first average brightness level L1 to a second average brightness level L2 (in this case, L2>L1). For example, the light-emitting characteristics of each light source in the light source array may be controlled proportionally or non-proportionally based on the second average brightness level and the light-emitting pattern data, such that the light source array displays a light-emitting pattern corresponding to the light-emitting pattern data while satisfying the second average brightness level.

In some cases, when the temperature of the light source array detected by the temperature sensor is less than the first predetermined threshold and greater than the second predetermined threshold, it can be determined that the light source array currently has no overheating risk, and thus the average brightness level of the light source array may not need adjustment. In this case, the light-emitting characteristics of each light source in the light source array may be directly controlled based on the light-emitting pattern data, such that the light source array displays the light-emitting pattern corresponding to the light-emitting pattern data.

By utilizing the light source control method according to one or more embodiments of the present disclosure, the temperature of the light source array can be monitored in real time and the average brightness level of the light source array can be adjusted accordingly to eliminate overheating risks, without sacrificing the overall light-emitting performance of the light source array. Additionally, apparent parameters of the light-emitting pattern, such as contrast and color saturation, which are more readily noticeable to users, can be improved. Various steps of the light source control method according to one or more embodiments of the present disclosure can be easily implemented via software control logic without increasing additional hardware design and implementation costs, thereby allowing flexible application to various types of consumer products containing light sources.

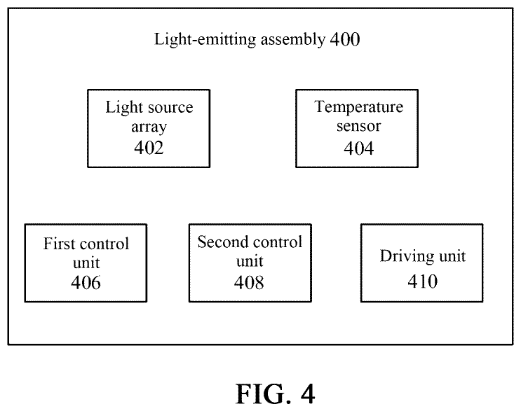

A light-emitting assembly according to one or more embodiments of the present disclosure is described below with reference to FIG. 4. FIG. 4 illustrates a schematic structural diagram of a light-emitting assembly 400 according to one or more embodiments of the present disclosure. Here, a light-emitting assembly may refer to any assembly or structure containing a light source. It may be an independent device (e.g., a lighting product), or may be integrated into other devices such as display devices, audio devices, etc., which is not specifically limited in the embodiments of the present disclosure.

As shown in FIG. 4, the light-emitting assembly 400 may include a light source array 402, a temperature sensor 404, a first control unit 406, a second control unit 408, and a driving unit 410. It can be understood that one or more of the components shown in FIG. 4 may be added, omitted, or combined according to actual design requirements, which is not specifically limited in the embodiments of the present disclosure. For example, the first control unit 406 and the second control unit 408 may be implemented by the same processor (e.g., a DSP) or integrated onto the same processing chip, which is not specifically limited in the embodiments of the present disclosure.

The light source array 402 may include a plurality of light sources. The plurality of light sources may be arranged into a one-dimensional, two-dimensional, or three-dimensional array according to any pattern, for example, arranged into a specific pattern, which is not specifically limited in the embodiments of the present disclosure. As mentioned above, each light source in the light source array may be an LED, OLED, laser light source, etc., and each light source may emit light of a different color, which is not specifically limited in the embodiments of the present disclosure.

The temperature sensor 404 is configured to measure the temperature of the light source array 402 in real time. Here, “measuring in real time” or “measuring in near real time” may refer to measuring at relatively small time intervals, which may be preset based on actual design requirements, for example. Additionally, the temperature sensor 404 may further be configured to monitor other components within the light-emitting assembly 400 that may generate heat, for example, a power supply, a processor, a storage device, etc. The heat generated by these components, combined with the heat generated by the light source array 402, may cause the light-emitting assembly 400 to overheat, thereby affecting the performance of the light-emitting assembly 400 and creating safety hazards. The light source array 402, as a primary heat source, can effectively reduce the overheating risk of the light-emitting assembly 400 if its heat generation can be controlled within a safe range.

The first control unit 406 is configured to determine, based on the light-emitting pattern data and the temperature of the light source array 402, to adjust an average brightness level of the light source array 402, so as to adjust the light source array 402 from a first average brightness level to a second average brightness level. In one or more embodiments of the present disclosure, the light-emitting pattern data is data for controlling the light-emitting characteristics of the light source array 402. Specifically, it may include data for controlling one or more of turning on or off, brightness, emission color, emission time, emission direction, rotation, or movement of each light source in the light source array 402 in each time frame. Thus, based on this light-emitting pattern data, the light-emitting characteristics of each light source in the light source array 402 can be controlled, such that the light emitted by the light source array as a whole can form a specific light-emitting pattern, such as flowers, animals, landscapes, etc. According to one or more embodiments of the present disclosure, the light-emitting pattern data may be preset and stored in a local memory of the device containing the light-emitting assembly 400. According to one or more embodiments of the present disclosure, the light-emitting assembly 400 may further include a communication unit (not shown), which may be configured to receive the light-emitting pattern data from a remote device (e.g., a smart device, a server, the cloud, etc.) in a wired or wireless manner. For example, the communication unit of the light-emitting assembly 400 may receive the light-emitting pattern data from the remote device using a wireless method such as Bluetooth or WiFi.

The light-emitting pattern data may be used to control the brightness of each light source in the light source array 402. The combined brightness of all light sources determines the average brightness level of the light source array 402. If the average brightness level of the light source array 402 is too high, meaning that the power consumption is too high, it may cause the light source array 402 to overheat. At this point, the temperature of the light source array 404 measured by the temperature sensor may exceed a first predetermined threshold. In a case where the temperature of the light source array 402 is greater than the first predetermined threshold, the average brightness level of the light source array 402 may be adjusted. For example, the first average brightness level L1 of the light source array 402 may be decreased by a specific percentage to a second average brightness level L2 (in this case, L1>L2) to reduce the overall power consumption of the light source array, thereby achieving the purpose of lowering the temperature of the light source array 402.

The second control unit 408 is configured to generate, based on the second average brightness level and the light-emitting pattern data, control data for non-proportionally controlling the light-emitting characteristics of each light source in the light source array 402. Using this control data, the driving unit 410 can drive the light source array 402 to display a light-emitting pattern corresponding to the light-emitting pattern data while satisfying the second average brightness level. Here, the driving unit 410 is configured to drive each light source in the light source array 402 according to the control data from the second control unit 408, such that each light source exhibits corresponding light-emitting characteristics. For example, the driving unit 410 may change the turning on/off, brightness, emission color, emission time, etc., of each light source by precisely controlling the current flowing through each light source. As another example, the driving unit 410 may also include motors for changing the emission direction, rotation, or movement, etc., of the light sources.

Specifically, for example, while causing the light source array 402 to satisfy the second average brightness level, brightness of a first part of light sources in the light source array 402 may be increased and brightness of a second part of light sources in the light source array 402 may be decreased based on the light-emitting pattern data. That is, the brightness of each light source in the light source array 402 is adjusted at a different level or proportion.

Furthermore, it is assumed that, in a case where brightness of all light sources in the light source array 402 is adjusted proportionally to cause the light source array 402 to reach the second average brightness level, the brightness of each light source is set to a temporary value. According to one or more embodiments of the present disclosure, the second control unit 408 is configured to adjust brightness of each light source in a first part of light sources in the light source array 402 to be greater than a temporary value thereof, and adjust brightness of each light source in a second part of light sources in the light source array 402 to be less than a temporary value thereof based on the light-emitting pattern data, as specifically described above in conjunction with FIG. 3, which will not be repeated here.

The second control unit 408 may determine the specific adjustment logic for each light source in the light source array based on characteristics of the light-emitting pattern. For example, if one part of the desired light-emitting pattern is brighter and another part is darker, the second control unit 408 may determine to adjust the brightness of the light sources corresponding to the brighter pattern part to be greater than their temporary values, while adjusting the brightness of the light sources corresponding to the darker pattern part to be less than their temporary values, while ensuring that the overall average brightness level of the light-emitting pattern is lowered. Combining with a specific example for illustration, for instance, if the light-emitting pattern corresponding to the light-emitting pattern data is a night sky, the second control unit 408 may determine, under the premise of lowering the overall average brightness level of the light-emitting pattern, to adjust the brightness of the light sources corresponding to the moon and stars to be greater than their temporary values, and adjust the brightness of the light sources corresponding to the sky to be less than their temporary values, for example, directly turning off the corresponding light sources.

Through this non-proportional adjustment method, the brightness of the parts of the light-emitting pattern that users focus more on (e.g., the moon and stars) does not decrease significantly, and may even increase, while the brightness of the parts of the light-emitting pattern that users pay less attention to (e.g., the night sky) decreases significantly. Thus, although the average brightness level of the light-emitting pattern drops, users may not perceive a significant change in brightness, and the contrast of the light-emitting pattern can also be improved. Similarly, the second control unit 408 may further control light-emitting characteristics such as turning on or off, emission color, and emission direction of each light source in the light source array non-proportionally, thereby improving the color saturation of the light-emitting pattern.

Since the temperature sensor 404 measures the temperature of the light source array 402 in near real time, in a case where the detected temperature of the light source array 402 is less than a second predetermined threshold, for example, when the temperature of the light source array 402 has dropped to a level far insufficient to cause an overheating risk, in order to provide better light-emitting performance, the average brightness level of the light source array 402 may be increased, for example, increased from a first average brightness level L1 to a second average brightness level L2 (in this case, L2>L1). For example, the light-emitting characteristics of each light source in the light source array 402 may be controlled proportionally or non-proportionally based on the second average brightness level and the light-emitting pattern data, such that the light source array 402 displays a light-emitting pattern corresponding to the light-emitting pattern data while satisfying the second average brightness level.

In some cases, when the temperature of the light source array 402 detected by the temperature sensor 404 is less than the first predetermined threshold and greater than the second predetermined threshold, the first control unit 406 may determine that the light source array 402 currently has no overheating risk, and thus may determine that the average brightness level of the light source array 402 does not need adjustment. In this case, the second control unit 408 may directly control the light-emitting characteristics of each light source in the light source array based on the light-emitting pattern data, such that the light source array displays the light-emitting pattern corresponding to the light-emitting pattern data.

By utilizing the light-emitting assembly 400 according to one or more embodiments of the present disclosure, the temperature of the light source array can be monitored in real time and the average brightness level of the light source array can be adjusted accordingly to eliminate overheating risks, without sacrificing the overall light-emitting performance of the light source array. Additionally, apparent parameters of the light-emitting pattern, such as contrast and color saturation, which are more readily noticeable to users, can be improved. The various processes of the light-emitting assembly 400 according to one or more embodiments of the present disclosure can be easily implemented via software control logic without increasing additional hardware design and implementation costs, thereby allowing flexible application to various types of consumer products containing light sources.

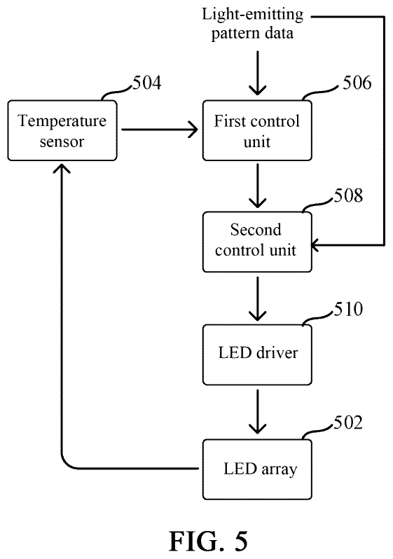

To provide a more intuitive description, FIG. 5 further illustrates a process flow of an example light-emitting assembly 500 according to one or more embodiments of the present disclosure. By way of example and not limitation, FIG. 5 illustrates a configuration where the light-emitting assembly 500 may include an LED array 502, a temperature sensor 504, a first control unit 506, a second control unit 508, and an LED driver 510. Here, 502 to 508 may correspond to 402 to 408 described above with reference to FIG. 4, respectively, and therefore, repeated descriptions of some contents are omitted here.

As shown in FIG. 5, the temperature sensor 504 may measure the temperature of the LED array 502 in real time and feed it, along with the light-emitting pattern data, to the first control unit 506. If the temperature of the LED array 502 exceeds a first temperature threshold, the first control unit 506 may determine that the LED array 502 is at risk of overheating, thereby determining that the LED array 502 needs to be adjusted from a first average brightness level to a second average brightness level. Subsequently, the second control unit 508 may generate, based on the second average brightness level and the light-emitting pattern data, control data for non-proportionally controlling the light-emitting characteristics of each light source in the LED array 502. Using this control data, the LED driver 510 can drive the LED array 502 to display a light-emitting pattern corresponding to the light-emitting pattern data while satisfying the second average brightness level, thereby eliminating the overheating risk without significantly affecting the light-emitting performance of the light-emitting assembly. In some cases, for example, when it is determined based on the temperature of the LED array 502 that it has no overheating risk, the light-emitting pattern data may also be directly provided to the second control unit 508, as shown in FIG. 5. Then, the second control unit 508 generates, based on the light-emitting pattern data, control data for controlling the LED array 502, such that the LED driver 510 can drive, under the action of this control data, the LED array 502 to display a light-emitting pattern corresponding to the light-emitting pattern data.

According to one or more embodiments of the present disclosure, an audio device is further provided, which may include the light-emitting assembly described above with reference to FIG. 4 or FIG. 5. For example, the audio device may be a speaker device capable of producing light shows.

One or more embodiments of the present disclosure may also be implemented as a computer-readable storage medium. A computer-readable storage medium according to one or more embodiments of the present disclosure has computer-readable instructions stored thereon, where the computer-readable instructions, when executed by a processor, cause the processor to execute the light source control method according to the embodiments of the present disclosure described with reference to the above drawings. The computer-readable storage medium includes, but is not limited to, for example, a volatile memory and/or nonvolatile memory. The volatile memory may include, for example, a random access memory (RAM) and/or a cache memory (cache), and the like. The non-volatile memory may include, for example, a read-only memory (ROM), a hard disk, a flash memory, and the like.

According to one or more embodiments of the present disclosure, a computer program product or a computer program is further provided. The computer program product or the computer program includes computer-readable instructions, and the computer-readable instructions are stored in a computer-readable storage medium. A processor of a computer device may read the computer-readable instructions from the computer-readable storage medium. The processor executes the computer-readable instructions to cause the computer device to perform the light source control method described in the aforementioned one or more embodiments.

The program portion of the technology may be considered as a “product” or “artifact” existing in the form of executable codes and/or associated data, which is engaged or implemented through a computer-readable medium. A tangible, permanent storage medium may include any memory or storage used by any computer, processor, or similar device or related modules, such as various semiconductor memories, tape drives, disk drives, or any similar device capable of providing storage functionality for software.

All of the software or portions thereof may from time to time communicate over a network, such as the Internet or other communications networks. Such communication may load software from one computer device or processor to another. Therefore, another medium capable of transferring software elements may also be used as a physical connection between local devices, such as light wave, radio wave, electromagnetic wave, etc., which are propagated through cables, optical cables, or air. The physical medium used to carry waves, such as cables, wireless links, optical cables and the like devices, may also be considered a medium for carrying the software. As used herein, unless restricted to tangible “storage” media, other terms referring to computer or machine “readable media” refer to media that participate in the process of a processor executing any instructions.

The present application uses specific words to describe embodiments of the present application. For example, “first/second embodiment”, “an embodiment”, and/or “some embodiments” means a feature, structure, or characteristic associated with at least one embodiment of the present application. Accordingly, it should be emphasized and noted that “an embodiment” or “one embodiment” or “an alternative embodiment” referred to two or more times in different places in this specification does not necessarily refer to the same embodiment. In addition, certain features, structures, or characteristics of one or more embodiments of the present application may be combined as appropriate.

In addition, it can be understood by those skilled in the art that aspects of the present application may be illustrated and described by a number of patentable categories or circumstances, including any new and useful process, machine, product, or combination of substances, or any new and useful improvement thereof. Accordingly, aspects of the present application may be performed entirely by hardware, may be performed entirely by software (including firmware, resident software, microcode, or the like), or may be performed by a combination of hardware and software. All of the above hardware or software may be referred to as “data blocks”, “modules”, “engines”, “units”, “components” or “systems”. Additionally, aspects of the present application may be manifested as a computer product disposed in one or more computer-readable media, the product including computer-readable program code.

Unless otherwise defined, all terms used herein, including technical and scientific terms, have the same meaning as commonly understood by those of ordinary skill in the art to which the present disclosure belongs. It should also be understood that terms such as those defined in common dictionaries should be construed as having a meaning consistent with their meaning in the context of the relevant technology and should not be construed with idealized or extremely formalized meanings unless expressly defined as such herein.

The foregoing is a description of the present disclosure and should not be considered a limitation thereof. Although several exemplary embodiments of the present disclosure are described, it will be readily understood by those skilled in the art that many modifications can be made to the exemplary embodiments without departing from the novel teachings and advantages of the present disclosure. Accordingly, all such modifications are intended to be encompassed within the scope of the present disclosure as defined by the claims. It should be understood that the foregoing is a description of the present disclosure and should not be considered to be limited to the particular embodiments as disclosed, and that modifications to the disclosed embodiments, as well as other embodiments, are intended to be included within the scope of the appended claims. The present disclosure is defined by the claims and equivalents thereof.

What is claimed is:

1. A method, comprising:
acquiring light-emitting pattern data for controlling light-emitting characteristics of a light source array, the light source array comprising a plurality of light sources;
measuring a temperature of the light source array in real time using a temperature sensor;
determining, based on the light-emitting pattern data and the temperature of the light source array, to adjust the light source array from a first average brightness level to a second average brightness level; and
controlling light-emitting characteristics of each light source in the light source array non-proportionally based on the second average brightness level and the light-emitting pattern data, such that the light source array displays a light-emitting pattern corresponding to the light-emitting pattern data while satisfying the second average brightness level.

2. The method according to claim 1, wherein the light-emitting pattern data comprises data for controlling one or more of turning on or off, brightness, emission color, emission time, emission direction, rotation, or movement of each light source in the light source array in each time frame.

3. The method according to claim 1, wherein determining, based on the light-emitting pattern data and the temperature of the light source array, to adjust the light source array from the first average brightness level to the second average brightness level comprises:
determining, in a case where the temperature of the light source array is greater than a first predetermined threshold, to decrease the light source array from the first average brightness level to the second average brightness level; and
determining, in a case where the temperature of the light source array is less than a second predetermined threshold, to increase the light source array from the first average brightness level to the second average brightness level.

4. The method according to claim 1, wherein controlling the light-emitting characteristics of each light source in the light source array non-proportionally based on the second average brightness level and the light-emitting pattern data comprises:
while causing the light source array to satisfy the second average brightness level, increasing brightness of a first part of light sources in the light source array and decreasing brightness of a second part of light sources in the light source array based on the light-emitting pattern data.

5. The method according to claim 1, wherein controlling the light-emitting characteristics of each light source in the light source array non-proportionally based on the second average brightness level and the light-emitting pattern data comprises:
while causing the light source array to satisfy the second average brightness level, adjusting brightness of each light source in a first part of light sources in the light source array to be greater than a temporary value thereof and adjusting brightness of each light source in a second part of light sources in the light source array to be less than a temporary value thereof based on the light-emitting pattern data.

6. The method according to claim 5, wherein the temporary value of each light source in the light source array is a brightness value of the light source in a case where brightness of all light sources is adjusted proportionally to cause the light source array to reach the second average brightness level.

7. The method according to claim 1, wherein acquiring the light-emitting pattern data for controlling the light-emitting characteristics of the light source array comprises:
acquiring the light-emitting pattern data from a local memory; or
receiving the light-emitting pattern data from a remote device in a wired or wireless manner.

8. A light-emitting assembly, comprising:
a light source array, the light source array comprising a plurality of light sources;
a temperature sensor configured to measure a temperature of the light source array in real time;
a first control unit configured to determine, based on light-emitting pattern data and the temperature of the light source array, to adjust the light source array from a first average brightness level to a second average brightness level;
a second control unit configured to generate, based on the second average brightness level and the light-emitting pattern data, control data for non-proportionally controlling light-emitting characteristics of each light source in the light source array; and
a driving unit configured to use the control data to drive the light source array to emit light, such that the light source array displays a light-emitting pattern corresponding to the light-emitting pattern data while satisfying the second average brightness level.

9. The light-emitting assembly according to claim 8, further comprising at least one speaker configured to emit sound.

10. A non-transitory computer-readable storage medium having computer-readable instructions stored thereon, wherein the computer-readable instructions, when executed by a processor, cause the processor to perform the steps of:
acquiring light-emitting pattern data for controlling light-emitting characteristics of a light source array, the light source array comprising a plurality of light sources;
measuring a temperature of the light source array in real time using a temperature sensor;
determining, based on the light-emitting pattern data and the temperature of the light source array, to adjust the light source array from a first average brightness level to a second average brightness level; and
controlling light-emitting characteristics of each light source in the light source array non-proportionally based on the second average brightness level and the light-emitting pattern data, such that the light source array displays a light-emitting pattern corresponding to the light-emitting pattern data while satisfying the second average brightness level.

11. The non-transitory computer-readable medium of claim 10, wherein the light-emitting pattern data comprises data for controlling one or more of turning on or off, brightness, emission color, emission time, emission direction, rotation, or movement of each light source in the light source array in each time frame.

12. The non-transitory computer-readable medium of claim 10, wherein determining, based on the light-emitting pattern data and the temperature of the light source array, to adjust the light source array from the first average brightness level to the second average brightness level comprises:
determining, in a case where the temperature of the light source array is greater than a first predetermined threshold, to decrease the light source array from the first average brightness level to the second average brightness level; and
determining, in a case where the temperature of the light source array is less than a second predetermined threshold, to increase the light source array from the first average brightness level to the second average brightness level.

13. The non-transitory computer-readable medium of claim 10, wherein controlling the light-emitting characteristics of each light source in the light source array non-proportionally based on the second average brightness level and the light-emitting pattern data comprises:
while causing the light source array to satisfy the second average brightness level, increasing brightness of a first part of light sources in the light source array and decreasing brightness of a second part of light sources in the light source array based on the light-emitting pattern data.

14. The non-transitory computer-readable medium of claim 10, wherein controlling the light-emitting characteristics of each light source in the light source array non-proportionally based on the second average brightness level and the light-emitting pattern data comprises:
while causing the light source array to satisfy the second average brightness level, adjusting brightness of each light source in a first part of light sources in the light source array to be greater than a temporary value thereof and adjusting brightness of each light source in a second part of light sources in the light source array to be less than a temporary value thereof based on the light-emitting pattern data.

15. The non-transitory computer-readable medium of claim 14, wherein the temporary value of each light source in the light source array is a brightness value of the light source in a case where brightness of all light sources is adjusted proportionally to cause the light source array to reach the second average brightness level.

16. The non-transitory computer-readable medium of claim 10, wherein acquiring the light-emitting pattern data for controlling the light-emitting characteristics of the light source array comprises:
acquiring the light-emitting pattern data from a local memory; or
receiving the light-emitting pattern data from a remote device in a wired or wireless manner.
